(19) United States
(12) Patent Application Publication
(10) Pub. No.: US 2024/0147021 A1
(43) Pub. Date: May 2, 2024

(54) Media Content Embedded Code Advertisement System and Method

(71) Applicants: Sarah Delaney, Monticello, MN (US); Kyle Thiede, Monticello, MN (US)

(72) Inventors: Sarah Delaney, Monticello, MN (US); Kyle Thiede, Monticello, MN (US)

(21) Appl. No.: 18/329,639

(22) Filed: Jun. 6, 2023

Related U.S. Application Data
(60) Provisional application No. 63/421,639, filed on Nov. 2, 2022.

(51) Int. Cl. H04N 21/81; G06Q 30/0601; H04N 21/4782; H04N 21/858

(52) U.S. Cl. CPC H04N 21/812; G06Q 30/0623; H04N 21/4782; H04N 21/8586

(57) ABSTRACT

The present invention relates to a media content embedded advertising link system and method. The system is configured to embed a Uniform Resource Locator code/matrix barcode, or other similar code in a product or item included in an audiovisual content including, but not limited to, television shows, movies, screen links, and more. The code/link can be scanned or clicked using an imaging device of a user device or through a remote control, or by touching the code/link on the display screen of a user device displaying the audiovisual content. The code/link redirects a viewer of the content to a product page of the item enabling the viewer to view details of the product and to purchase the product. The system enables the viewer to quickly ascertain where to purchase the desired item shown in the media content.

### CROSS-REFERENCE TO RELATED APPLICATION

The present application claims priority to, and the benefit of, U.S. Provisional Application No. 63/421,639, which was filed on Nov. 2, 2022, and is incorporated herein by reference in its entirety.

### FIELD OF THE INVENTION

The present invention relates generally to the field of media content and advertisements. More specifically, the present invention relates to a novel system and method for providing media content with embedded advertisement links. The system embeds at least one URL (Uniform Resource Locator) code, QR (i.e., matrix barcode) code, or other similar code or link of a product included in the media content such as, but not limited to. TV shows, movies, etc. The system enables users to quickly and easily view details and purchase items/products displayed in the media content by scanning or clicking the embedded link. Accordingly, the present disclosure makes specific reference thereto. Nonetheless, it is to be appreciated that aspects of the present invention are also equally applicable to other like applications, devices, and methods of manufacture.

### BACKGROUND

By way of background, TV shows, movies, video blogs and more are viewed by a lot of individuals and have large viewership. Such audiovisual content can be a great source of advertisement and revenue for manufacturers. In fact, product placement is a huge industry which involves embedding hidden advertising into films, TV series, video games, or any other audiovisual content. Product placement usually involves showing a product or a company logo design, or, if the producers consider it appropriate, characters may be seen discussing a particular brand. Viewers of such media content often like to view more details of such items shown in media content and even like to purchase the items.

However, currently, the viewers are required to spend considerable amount of effort, time, and energy to try to find the products displayed in the media content. Sources such as e-commerce websites where users can access and buy the items are manually searched by viewers. This may cause frustration and even lead the user to give up their search, which eliminates the possibility of a sale for the item seller and ends in a revenue loss. Both advertisers and viewers desire an improved system and method that enables viewers of media content to easily find and purchase products shown in video media content.

Therefore, there exists a long-felt need in the art for a system of displaying media content such as, but not limited to, TV shows, movies, etc. that enables a user to easily find products shown on the media content. There is also a long-felt need in the art for a system that increases revenue for item sellers showcasing their products in audiovisual media content. Additionally, there is a long-felt need in the art for a system that improves product placement in audiovisual content. Moreover, there is a long-felt need in the art for a system that enables viewers of audiovisual content to easily purchase items showcased in the content. Further, there is a long-felt need in the art for a system that enables viewers to directly reach (i.e., access) a product page of a product showcased in the audiovisual content. Finally, there is a long-felt need in the art for a media content system that uses an embedded advertising link for a user to ascertain quickly and easily a path to purchase the desired item shown in the content.

The subject matter disclosed and claimed herein, in one embodiment thereof, comprises a media content system for embedding an advertising link for an item showcased in an audiovisual content. The system is configured for generating the advertising link in the form of an encoded and scannable code, the code can be encoded with a URL code or QR code of a product page of the item, embedding the scannable code onto the item, and redirecting a viewer directly to the product page when the URL or QR code is scanned using an imaging device by the viewer. The scannable code is accessible to geographies preferred or selected by a seller of the item. In one embodiment, the link can simply be viewed by the viewer and typed into a browser to reach the product page.

In this manner, the media content system of the present invention accomplishes all of the forgoing objectives and provides users with a media content system with an embedded advertising link. The code or link is embedded in an item included in an audiovisual media content which can then be viewed by a viewer by scanning, clicking, or touching the code/link and or the item. The system eliminates manual searching for items by viewers and enables item sellers to increase their revenue. The system can be used with any smart device that can broadcast content.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for providing an embedded advertising link associated with a product shown in a media content. The method comprising the steps of creating a digital and dynamic scannable code for a product, the scannable code is encoded with URL of the product page of the product, superimposing or embedding the digital and dynamic scannable code on an image of the product, wherein the image is displayed in a media content, the image is one of a still image or a moving image in the form of a video. A user, upon scanning or clicking the scannable code using a user device on which the media content is displayed, is redirected to the product page enabling the user to view details of the product and purchase the product.

In a further embodiment of the present invention, a method of purchasing a product included in a media content which is displayed on a display screen of a user device is described. The method comprising the steps of receiving, on the display screen of the user device, a media content; the media content including at least one product; displaying, on the display screen of the user device, a dynamic link, scannable code, or matrix barcode when the at least one product is scanned, clicked, or touched on the display screen of the user device; redirecting the user to a product page of the product when the dynamic link or scannable code is clicked by the user; and presenting the user interface enabling a user to purchase the product or view the details of the product.

In a further embodiment of the present invention, a method is described and comprises the steps of receiving a media content, the media content including a product item having an embedded link associated therewith; initiating a display of the media content on a display interface of a user device, the display including displaying of the product item; upon successful activation of the embedded link, displaying a webpage including product details and purchase process of the associated product item; wherein, the embedded link redirects to the webpage.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a media content advertisement system of the present invention in accordance with the disclosed architecture;

FIG. 2 illustrates a flow diagram depicting a process of using an embedded code for purchasing a desired item displayed in a media content in accordance with the disclosed architecture;

FIG. 3 illustrates a flow diagram depicting a process of embedding a link or scannable code in a media content item in accordance with the disclosed architecture;

FIG. 4 illustrates a perspective view of an exemplary media content display offered by the media content system of the present invention in accordance with the disclosed architecture; and

FIG. 5 illustrates a flow diagram depicting a process of registration of manufacturers of, for example, furniture, accessories, and more in the media content advertisement system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system of displaying media content such as, but not limited to, TV shows, movies, etc. that enables a user to easily find products shown on the media content. There is also a long-felt need in the art for a system that increases revenue for sellers showcasing their products in audiovisual media content. Additionally, there is a long-felt need in the art for a system that improves product placement in audiovisual content. Moreover, there is a long-felt need in the art for a system that enables viewers of audiovisual content to easily purchase items showcased in the content. Further, there is a long-felt need in the art for a system that enables viewers to directly reach to a product page of a product showcased in the audiovisual content. Finally, there is a long-felt need in the art for a media content system that uses an embedded advertising link for a user to ascertain quickly and easily a link or path to purchase the desired item shown in the content.

The present invention, in one exemplary embodiment, is a method for providing an embedded advertising link or code associated with a product or item shown in an audiovisual content. The method comprising the steps of creating a digital and dynamic scannable code or link for a product, the scannable code can be encoded with a URL of the product page of the product, superimposing or embedding the digital and dynamic scannable code on the product, wherein the image is displayed in the audiovisual content. A viewer, upon scanning or clicking the scannable code or the product using a user device on which the media content is displayed, is redirected to the product page enabling the user to view details of the product and to purchase the product.

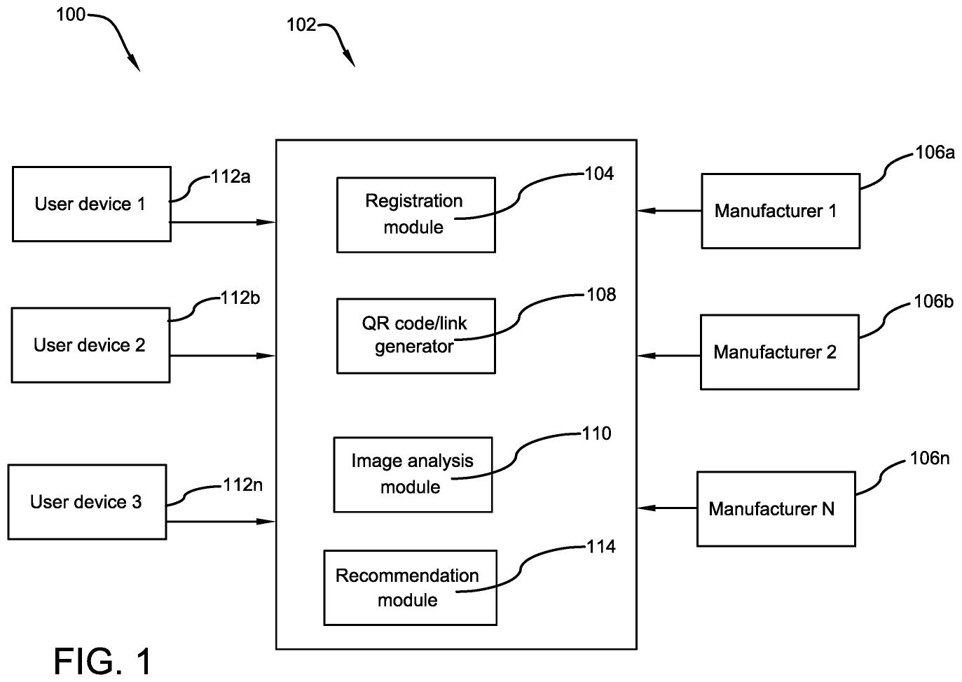

Referring initially to the drawings, FIG. 1 illustrates a schematic view of one potential embodiment of a media content advertisement system of the present invention in accordance with the disclosed architecture. The media content system 100 of the present invention is designed to allow manufacturers of products including, but not limited to, furniture, accessories, vehicles, jewelry, and many more to increase their revenue by adding a dynamic link of their product page in the images of their products included in media content of TV shows, movies, video blogs, and many more. The system 100 also enables users to scan the dynamic link to go directly to product pages for purchasing the items. More specifically, the system 100 includes a media content server 102 for processing media content to be shown in TV shows, movies, video blogs, and more. The dynamic link can be embedded in a display screen selected from a group consisting of a TV screen, a movie screen, a computer screen, and a cell phone screen. The server 102 can be of a media production house or can be of any third-party source.

The server 102 can be a network of computers, a software framework, or a combination thereof, that may provide a generalized approach to create the server implementation. The server 102 may include, but not be limited to, personal computers, laptops, mini-computers, mainframe computers, any non-transient and tangible machine that can execute a machine-readable code, cloud-based servers, distributed server networks, or a network of computer systems.

The server 102 has a registration module 104 for registering manufacturers 106a-n to avail services offered by the system 100. The registration module 104 is used for registering different products of manufacturers with which dynamic links or scannable codes are associated. In one embodiment of the present invention, a manufacturer may pay an upfront fee for registering in the system 100 and/or pay a commission for purchases completed by the viewers redirected to the product page. A QR code/link generator 108 is configured to generate a dynamic link or QR code associated with a product included in a media content. The QR code/link is embedded to the corresponding product in the media content using an image analysis module 110. In some embodiments, the embedded code is visible to users on their display screen when the product is displayed in the media content. In other embodiments, the link/code is visible only when the product is touched or clicked by the user interacting with a display screen of their user devices.

The server 102 is configured to provide media content with embedded advertising links to the user devices 112a-n of consumers of media content. Different networks include, but are not limited to, content delivery networks or any public networks used for delivering media content to the user devices 112a-n. In situations where the server 102 is maintained by a third-party, then, the embedded links can be provided to the media server used for distributing media to users.

A recommendation module 114 enables the embedded link/code to be displayed on devices that reside in preferred geographic areas established by manufacturers. In situations where a manufacturer is from the U.S, and the media content is streamed in both U.S. and India, then based on preferences of the manufacturer, the embedded link may be displayed only to user devices 112a-n accessing content within the U.S. In other embodiments, the embedded link may be displayed to users across the globe.

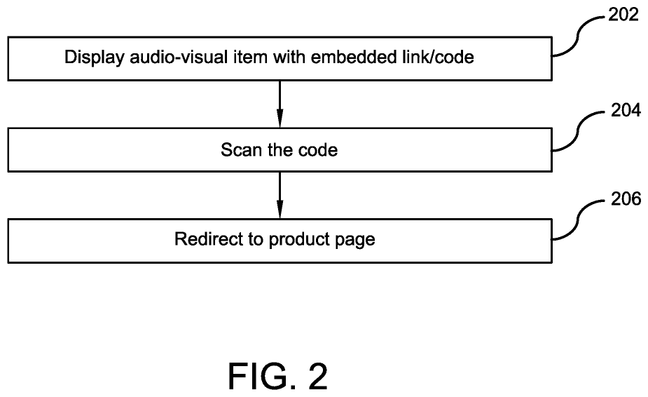

FIG. 2 illustrates a flow diagram depicting a process of using an embedded code for purchasing a desired item displayed in a media content in accordance with the disclosed architecture. Initially, an audiovisual item with an embedded QR code/URL code is displayed by the media content system of the present invention (Step 202). The embedded QR code/URL code is preferably encoded on the media content item using post processing of media content item as described later in the disclosure. Then, the embedded QR code/URL code is scanned by a user using an imaging device of a smartphone or a QR code reader (Step 204), Once, the QR code/URL code is scanned, then, the user is redirected to a product page of the item on which the QR code/URL code is positioned (Step 206). In some embodiments, the item/product is scanned, clicked, or touched to redirect to the product page.

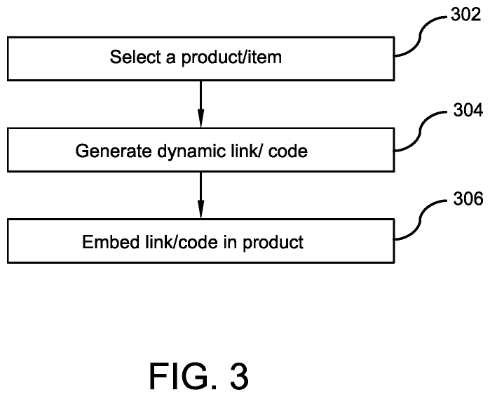

FIG. 3 illustrates a flow diagram depicting a process of embedding a link or scannable code in a media content item in accordance with the disclosed architecture. Initially, an item/product such as a furniture, accessory, or any other physical item in an audiovisual content is selected for embedding the link/scannable code (Step 302). Then, a dynamic link/code is generated wherein the code corresponds to a URL code of product page of the selected content item (Step 304). Thereafter, the link/code is dynamically superimposed on the selected item (Step 306). In some embodiments, the link/code is automatically visible to users when the content item is displayed on a display screen. In other embodiments, the link/code is not visible and can be accessed when the media item is touched or clicked by a user on the display screen.

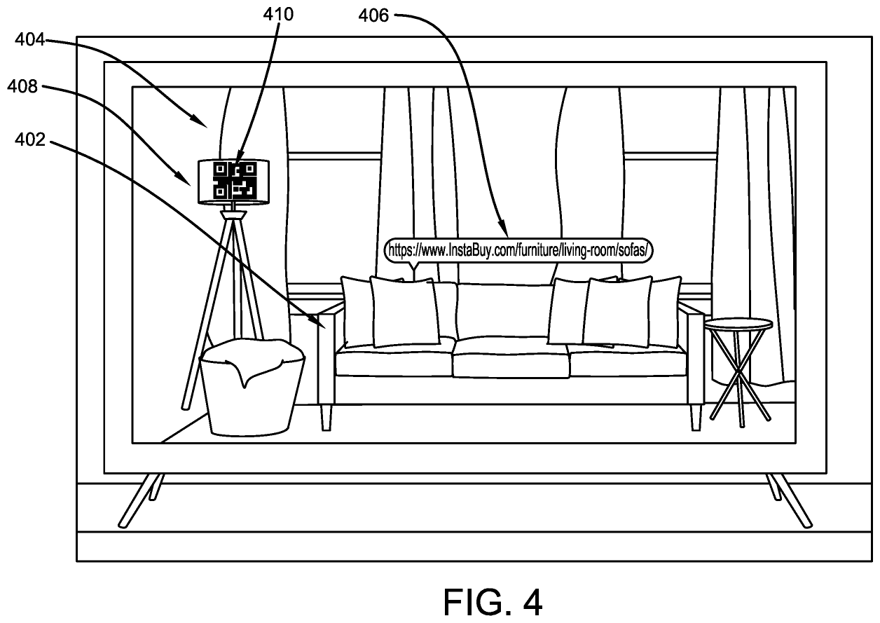

FIG. 4 illustrates a perspective view of an exemplary media content display offered by the media content system of the present invention in accordance with the disclosed architecture. The media content system 100 is designed to enable users to find, link, and buy items displayed in media content without manually searching for the displayed items. As illustrated, the couch 402 displayed in the media content 404 is associated with an embedded URL 406 such that the URL 406 corresponds to the product page of the couch 402 enabling a user to directly purchase the couch.

The URL 406 is displayed dynamically when a user scans, touches, or clicks on the image of the couch 402 through the display screen of the device in which the media content 404 is accessed by the user. The image of a floor lamp 408 included in the media content 404 has an embedded QR code 410 which can be displayed even without a user scanning, touching, or clicking the floor lamp 408. The QR code 410 when scanned takes the user to a corresponding product page enabling the user to find more details and to purchase the floor lamp 408.

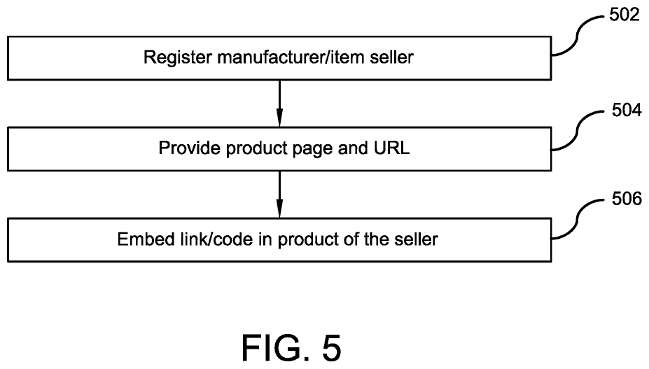

FIG. 5 illustrates a flow diagram depicting a process of registration of manufacturers of furniture, accessories, and more in the media content advertisement system of the present invention in accordance with the disclosed architecture. The present invention provides a system for manufacturers and sellers of items to increase their revenue and to market their products by providing a redirection or linking mechanism from media content to their product pages. Initially, a manufacturer/item seller is registered in the system 100 and provides details of their products included in the media processed by system 100 (Step 502). Then, a product page and an associated URL is provided to the system 100 by the manufacturer (Step 504). In some embodiments, a discount percentage or a coupon code is also provided by the manufacturer enabling the system 100 to automatically apply the coupon code for its subscribers.

Then, a dynamic code or link is generated by the system for linking to the product page wherein the code is superimposed or embedded in the product (i.e., image of the product) of the manufacturer displayed in the media content (Step 506).

All the communication between the server 102, user devices 112a-n, and item sellers 106a-n in the present disclosure is done using communication channels which may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “media content advertisement system”, “media content system”, and “system” are interchangeable and refer to the media content embedded link advertisement system 100 of the present invention.

Notwithstanding the forgoing, the media content embedded link advertisement system 100 of the present invention can be of any suitable configuration as is known in the art without affecting the overall concept of the invention, provided that it accomplishes the above-stated objectives. One of ordinary skill in the art will appreciate that the media content embedded link advertisement system 100 as shown in the FIGS. are for illustrative purposes only, and that many other configurations, components, and design of the media content embedded link advertisement system 100 are well within the scope of the present disclosure. Although the mentioned components of the media content embedded link advertisement system 100 are important design parameters for user convenience, the media content embedded link advertisement system 100 may contain any additional components that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A media content system for processing media content comprising:
a media content server comprising a non-transient and tangible machine for executing a machine-readable code, a media content display screen, a network of computers, and a software framework;
wherein said media content server is selected from a group consisting of a personal computer, a laptop, a mini-computer, and a mainframe computer;
wherein said media content server having a registration module for registering manufacturers for accessing services of said media content system;
wherein said registration module configured for registering products of said manufacturers; wherein said registering products comprising a scannable code associated with a registered product;
wherein said scannable code is selected from a QR code and a URL code; and
further wherein said scannable code is a dynamic link displayed on said media content display screen to redirect a viewer to a product page for said registered product.

2. The media content system for processing media content of claim 1, wherein said scannable code is embedded in said media content display screen.

3. The media content system for processing media content of claim 2, wherein said embedded said scannable code is visible to users on said media content display screen with associated said registered product.

4. The media content system for processing media content of claim 3, wherein said registering products including a fee from said manufacturers.

5. The media content system for processing media content of claim 4, wherein said fee is a commission related to a purchase of said registered product.

6. The media content system for processing media content of claim 3 further comprising an image analysis module for embedding and associating said registered product with said scannable code.

7. The media content system for processing media content of claim 6, wherein said embedded said scannable code is visible to the users on said media content display screen when said associated said registered product is displayed in said media content display screen.

8. The media content system for processing media content of claim 7, wherein said embedded said scannable code is detectable when said associated said registered product is touched by the user interacting with said media content display screen.

9. The media content system for processing media content of claim 7, wherein said embedded said scannable code is detectable when said associated said registered product is clicked by the user interacting with said media content display screen.

10. The media content system for processing media content of claim 7, wherein said media content display screen is selected from a group consisting of a TV screen, a movie screen, a computer screen, and a cell phone screen.

11. The media content system for processing media content of claim 10, wherein said media content server selected from a group consisting of a cloud-based server and a distributed server network.

12. A media content system for processing media content comprising:
a media content server comprising a non-transient and tangible machine for executing a machine-readable code, a media content display screen, a network of computers, and a software framework;
wherein said media content server is selected from a group consisting of a personal computer, a laptop, a mini-computer, and a mainframe computer;
wherein said media content server having a registration module for registering manufacturers for accessing services of said media content system;
wherein said registration module configured for registering products of said manufacturers; wherein said registering products comprising a scannable code associated with a registered product;
wherein said scannable code is selected from a QR code and a URL code;
wherein said scannable code is a dynamic link embedded code displayed on said media content display screen to redirect a viewer to a product page for said registered product;
wherein said media content server having a recommendation module for displaying said dynamic link embedded code in a selected geographic area; and
further wherein said recommendation module displays said dynamic link embedded code on said media content display screens in said selected geographic area.

13. The media content system for processing media content of claim 12, wherein said selected geographic area is established by said manufacturer.

14. The media content system for process media content of claim 13, wherein said scannable code is embedded in said media content display screen.

15. The media content system for processing media content of claim 14, wherein said dynamic link embedded code is visible to users on said media content display screen with associated said registered product.

16. The media content system for processing media content of claim 15 further comprising an image analysis module for embedding and associating said registered product with said scannable code.

17. The media content system for processing media content of claim 16, wherein said dynamic link embedded code is visible to the users on said media content display screen when said associated said registered product is displayed in said media content display screen.

18. The media content system for processing media content of claim 17, wherein said media content display screen is selected from a group consisting of a TV screen, a movie screen, a computer screen, and a cell phone screen.

19. A method of using embedded codes for purchasing of items, the method comprising the steps of:
providing a media content system having a media content server comprising a non-transient and tangible machine for executing a machine-readable code, a media content display screen, a network of computers, and a software framework;
wherein said media content server is selected from a group consisting of a personal computer, a laptop, a mini-computer, and a mainframe computer;
registering manufacturers with said media content server for accessing services of said media content system;
registering products of said registered manufacturers;
associating a scannable code with said registered products and said registered manufacturers;
wherein said scannable code is a dynamic link embedded code selected from a QR code and a URL code;
redirecting a viewer to a product page for said registered products upon scanning said scannable code on said media content display screen;
wherein said media content server having a recommendation module for displaying said dynamic link embedded code in a selected geographic area; and
displaying said dynamic link embedded code on said media content display screens in said selected geographic area.

20. The method of using embedded codes for purchasing of items of claim 19, wherein said selected geographic area is established by said manufacturer.
